(19) United States
(12) Patent Application Publication
(10) Pub. No.: US 2008/0078818 A1
(43) Pub. Date: Apr. 3, 2008

(54) EXPANDABLE FILE BOX

(76) Inventor: Amy Botkin, Dayton, OH (US)

Correspondence Address: MEADWESTVACO CORPORATION, 1021 MAIN CAMPUS DRIVE, CENTENNIAL CAMPUS, RALEIGH, NC, 27606, US

(21) Appl. No.: 11/854,041

(22) Filed: Sep. 12, 2007

Related U.S. Application Data
(60) Provisional application No. 60/843,820, filed on Sep. 12, 2006.

(51) Int. Cl. B42F 7/14

(52) U.S. Cl. 229/101

(57) ABSTRACT

An expandable file box includes a pair of front and rear assemblies coupled together by a gusset assembly for movement toward and away from each other. Each of the front and rear assemblies includes a main panel. The main panels of the front and rear assemblies are disposed in an opposed relationship such that the gusset assembly extends between the front and rear main panels and thereby an expandable cavity for receiving an item is defined by the front and rear main panels as well as by the gusset assembly. The one of the front and rear assemblies further includes a pair of opposed side panels disposed outside the expandable cavity such that at least part of the gusset assembly is hidden from view by the side panels.

### CROSS-REFERENCE TO RELATED APPLICATION

This application claims the benefit of the filing date of U.S. Provisional Application Ser. No. 60/843,820, entitled “Expandable File Box” filed on Sep. 12, 2006, the entirety of which is incorporated herein by reference.

### BACKGROUND

This application is directed generally to a file box, and more particularly to an expandable file box for stationary.

Conventional loose-page stationary storage systems include binders, which typically include a front and rear cover, as well as a binding mechanism, such as a 3-ring binding mechanism, to secure the pages to the binder. However, as more and more pages are stored over time, these conventional storage systems rapidly become too bulky for convenient inspection. In addition, such storage systems may require that the components to be stored therein have holes punched therein.

Accordingly, there is a need for a high-capacity, expandable storage system where loose-page pages can be stored in a compact arrangement and can be easily inspected by the user.

### SUMMARY

In one embodiment, the present invention is an expandable file box having a front assembly and a rear assembly. Each assembly includes a main panel and a pair of opposed side panels oriented generally parallel to each other and generally perpendicular to the associated main panel. A gusset assembly, that may be formed of a pair of side gussets and a bottom gusset, extends between the front and rear assemblies to couple them together. The assemblies are nested together such that the side panels overlap and the assemblies define an expandable cavity therebetween.

In one embodiment, one of the front and rear assemblies may be pivotable about a horizontal axis, generally away from the other of the front and rear assemblies thereby expanding the expandable cavity therebetween. In another embodiment, one of the front and rear assemblies may be linearly movable away from the other of the front and rear assemblies thereby expanding the expandable cavity therebetween.

Another embodiment of the invention is a method for manipulating a expandable file box including the steps of: providing an expandable file box having a front assembly and a rear assembly, wherein each assembly includes a main panel, a pair of opposed side panels oriented generally parallel to each other and generally perpendicular to the associated main panel, and a pair of expandable side gussets extending between the front and rear assemblies and coupling the assemblies together, wherein the assemblies are nested together such that the side panels overlap and the assemblies define an expandable cavity therebetween; collecting a plurality of items that require filing; and inserting the plurality of items into the expandable cavity.

Another aspect of the invention provides an expandable file box that includes a pair of front and rear assemblies coupled together by a gusset assembly (e.g., the structure formed from the gussets 20, 21 and 23 in FIGS. 3 and 6) for movement toward and away from each other. Each of the front and rear assemblies includes a main panel. The main panels of the front and rear assemblies are disposed in an opposed relationship such that the gusset assembly extends between the front and rear main panels and thereby an expandable cavity for receiving an item is defined by the front and rear main panels and by the gusset assembly. The front or rear assembly further includes a pair of opposed side panels disposed outside the expandable cavity such that at least part of the gusset assembly is hidden from view by the side panels.

In one embodiment, the gusset assembly may include a pair of opposed side gussets. The side panels may be disposed alongside the external sides of the side gussets respectively. Each side gusset may be of a pleated panel structure, and the side panels may be disposed to hide the pleated panel structure from view.

In another embodiment, the side panels may be disposed generally perpendicular to the main panel.

In another embodiment, the other of the front and rear assemblies may further include a pair of opposed side panels extending toward the one of the front and rear assembly. The side panels of the other of the front and rear assemblies may be disposed outside the expandable cavity such that at least part of the gusset assembly is hidden from view by the side panels of the other of the front and rear assemblies. The side panels of the one of the rear and front assemblies may be disposed in an overlapping relationship respectively with the side panels of the other of the front and rear assemblies. Alternatively, the side panels of the one of the rear and front assemblies are disposed in a face contacting relationship respectively with the side panels of the other of the front and rear assemblies for sliding movement so that the main panel of the front and rear assemblies are movable toward and away from each other. Alternatively, the side panels of the other of the front and rear assemblies are disposed along the respective outside surfaces of the side panels of the one of the front and rear assemblies.

In the embodiment wherein the gusset assembly includes the opposed side gussets, the other of the front and rear assemblies may further include a pair of opposed side panels extending toward the one of the front and rear assemblies. The side panels of the other of the front and rear assemblies may be disposed alongside the external sides of the side gussets respectively. The side panels of the front and rear assemblies may be disposed such that the side gussets are entirely hidden from view when the file box is viewed from either side of the file box.

In the embodiment where each of the front and rear assemblies has the side panels, the front and rear assemblies may be movable toward each other to allow the file box to take a collapsed form in which the side panels of the one of the rear and front assemblies are substantially covered respectively by the side panels of the other of the front and rear assemblies.

In yet another embodiment, the other of the front and rear assembly may further include a stopper for limiting the movement of the front and rear assembly toward each other. The front and rear assemblies may be movable toward each other to allow the file box to take a collapsed form in which the stopper is disposed in abutment with the side panels of the one of the front and rear assemblies. The front assembly may include the stopper, the rear assembly may include the side panels, and the respective front edges of the side panels may be brought into abutment with the stopper when the files box is in the collapsed form.

In a further embodiment, one of the front and rear assembly may further include a stopper for restricting the movement of the front and rear assembly away from each other. The stopper may comprise a cover flap extendable from the one of the front and rear assemblies and securable to the other of the front and rear assemblies.

In a further embodiment, one of the front and rear assembly may further include a bottom panel disposed under the expandable cavity.

In a further embodiment, the gusset assembly may be free of restraint by the side panels of the one of the front and rear assemblies.

In a further embodiment, the front and rear assemblies may be pivotable about a horizontal axis with respect to the other.

In a further embodiment, the gusset assembly may include one or more dividers for defining two or more separate compartments within the cavity.

Another aspect of the invention provides an accordion folder which includes a pair of front and rear panel and a pair of covering panels. The front and rear opposed panels are interconnected by an accordion connector to define an expandable cavity for receiving an item such as a sheet of paper. The accordion connector has a pair of opposed pleated side walls. The opposed cover panels extend from one of the front and rear panels to be disposed alongside the pleated side walls respectively so that at least part of the pleated side walls is hidden from view by the cover panels.

In one embodiment, a second pair of opposed cover panels may extend from the other of the front and rear panels to be disposed alongside the pleated side walls respectively such that at least part of the cover panels of the first pair is hidden from view by the cover panels of the second pair. The front and rear panels may be movable toward each other to allow the accordion folder to take a collapsed form in which the cover panels of the first pair are substantially covered respectively by the cover panels of the second pair. Alternatively, the cover panels of the first pair are disposed in a face contacting relationship respectively with the cover panels of the second pair for sliding movement so that the front and rear panels are movable toward and away from each other.

In another embodiment, the accordion connector may further include a pleated bottom wall extending between the pleated side walls. A bottom cover panel may extend from one of the front and rear panels to be disposed under the pleated bottom wall.

Other aspects of the invention will become apparent from the following description and the accompanying drawings.

### BRIEF DESCRIPTION OF THE DRAWINGS

FIG. 1 is a front perspective view of one embodiment of a expandable file box of the present invention, showing the file box in a closed position;

FIG. 2 is a front perspective view of the file box of FIG. 1, showing the file box in an open position and in conjunction with a sheet of paper;

FIG. 3 is a front perspective view of the file box of FIG. 2, showing the file box in an expanded position;

FIG. 4 is a side view of the file box of FIG. 2, showing the front assembly in a pivoted position; and

FIG. 5 is a side view of the file box of FIG. 3.

FIG. 6 is a bottom view of the file box of FIG. 3.

### DETAILED DESCRIPTION

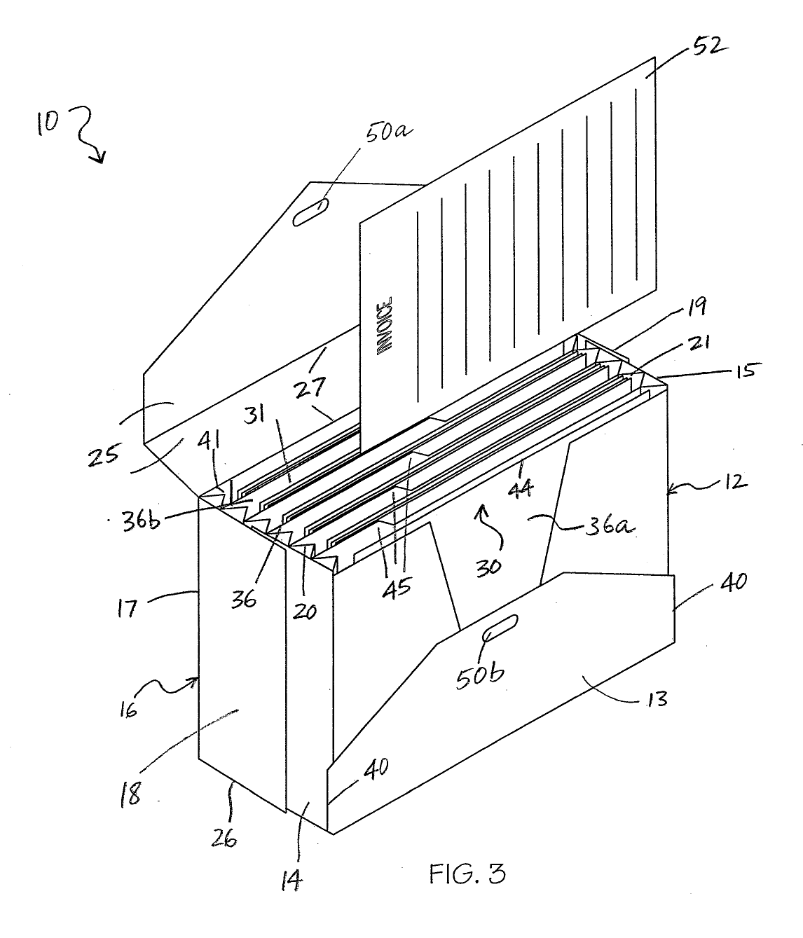

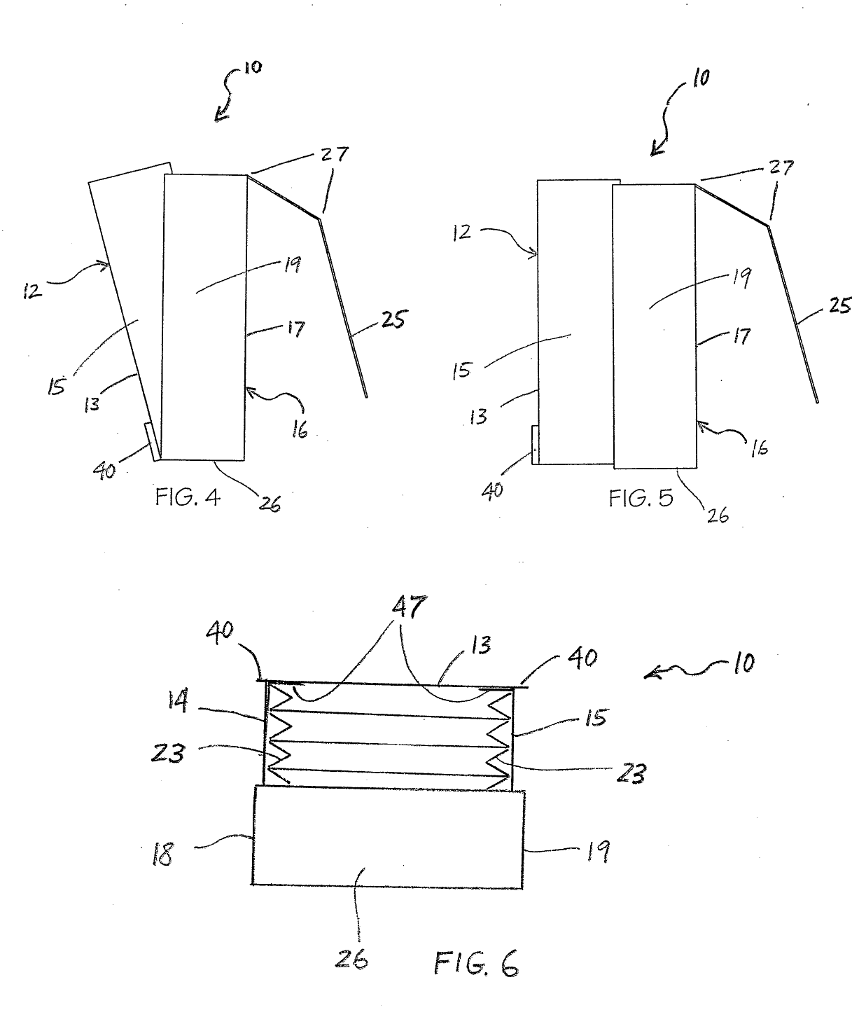

In one embodiment of the present invention, as shown in FIG. 3, an expandable file box, generally denoted 10, includes a front assembly, generally denoted 12 and a rear assembly, generally denoted 16. Each assembly 12, 16 includes an associated main panel 13, 17 and a pair of opposed side panels 14, 15 and 18, 19 oriented generally parallel to each other and generally perpendicular to the associated main panel 13, 17. The front assembly 12 includes the front main panel 13 and associated front-side panels 14, 15 that are coupled to the front main panel 13 along its opposed side edges and extend toward the rear assembly 16. The rear assembly 16 includes the rear main panel 17 and associated rear-side panels 18, 19 that are coupled to the rear main panel 17 and extend toward the front main panel 13. A pair of side gussets 20, 21 and a bottom gusset 23 (see FIG. 6) extend between the main panels 13, 17 of each assembly 12, 16. The side gusset 20 is flanked by the side panels 14, 18 while the side gusset 21 is flanked by the side panels 15, 19. In other words, the side gussets 20, 21 are disposed along the inside surfaces of the side panels 14, 18 and the side panels 15, 19 and therefore the side gussets 20, 21 are hidden from view when the file box is viewed from either side of the file box as appreciated in FIGS. 4 and 5. The bottom gusset 23 connects between the lower ends of the side gussets 20, 21. These side and bottom gussets 20, 21, 23 couple the front and rear assemblies 12, 16 together (see FIG. 3).

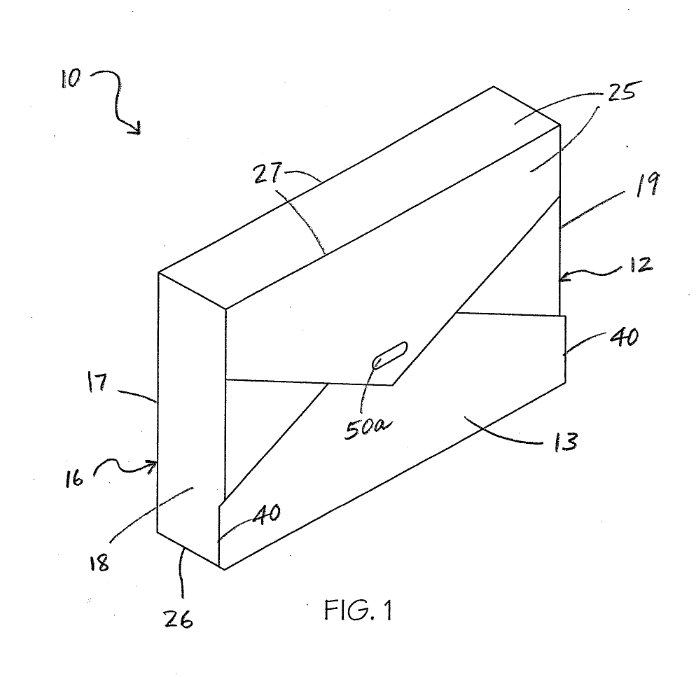

The assemblies 12, 16 are nested together such that the side panels 14, 15 of the front assembly 12 overlap and slidably engage the side panels 18, 19 of the rear assembly 16. The sildable connection between the side panels and the gussets 20, 21, 23 allow the assemblies 12, 16 to be movable with respect to each other in such a manner that an expandable cavity 30 for receiving flat items is defined by the assemblies 12, 16 and the gussets 20, 21, 23. When the front and rear main panels 13, 17 are moved toward each other to their limit (which will be described later), the gussets 20, 21, 23 are contracted to allow the file box 10 to take a collapsed form as shown in FIG. 1 in which the file box 10 has the minimum capacity. In the collapsed form, the front assembly 12 is fully received within the rear assembly 16 such that the side panels 14, 15 substantially entirely overlap with and are fully covered by, the associated side panels 18, 19. When the front and rear main panels 13, 17 are moved away from each other within the tolerance of the gussets 20, 21, 23, the file box 10 takes an expanded form as shown in FIG. 3 in which the file box 10 has a greater or the minimum capacity. In the expanded form, the front assembly 12 is partially withdrawn from the rear assembly 16 such that the side panels 14, 15 only partially overlap with the associated side panels 18, 19.

The front assembly 12 and rear assembly 16, including the main panels 13, 17 and side panels 14, 15, 18, 19, can be made of a variety of materials, such as cardboard, paperboard, plastic, tweeds, faux leathers, cottons, silks, combinations of these materials, and the like. The expandable side gussets 20, 21 and bottom gusset 23 may be of an expandable structure or made of expandable material or have a combination of both. The expandable structure, for example, may be provided by gusseted or pleated sheet material, as shown in the illustrated embodiment, but may also be provided by simply folded or creased sheet material. The expandable material may include, but not limited to, elastic material such as natural rubbers, synthetic rubbers, elastomeric plastics, wovens or braided fabrics containing elastic fibers, spandex, etc.

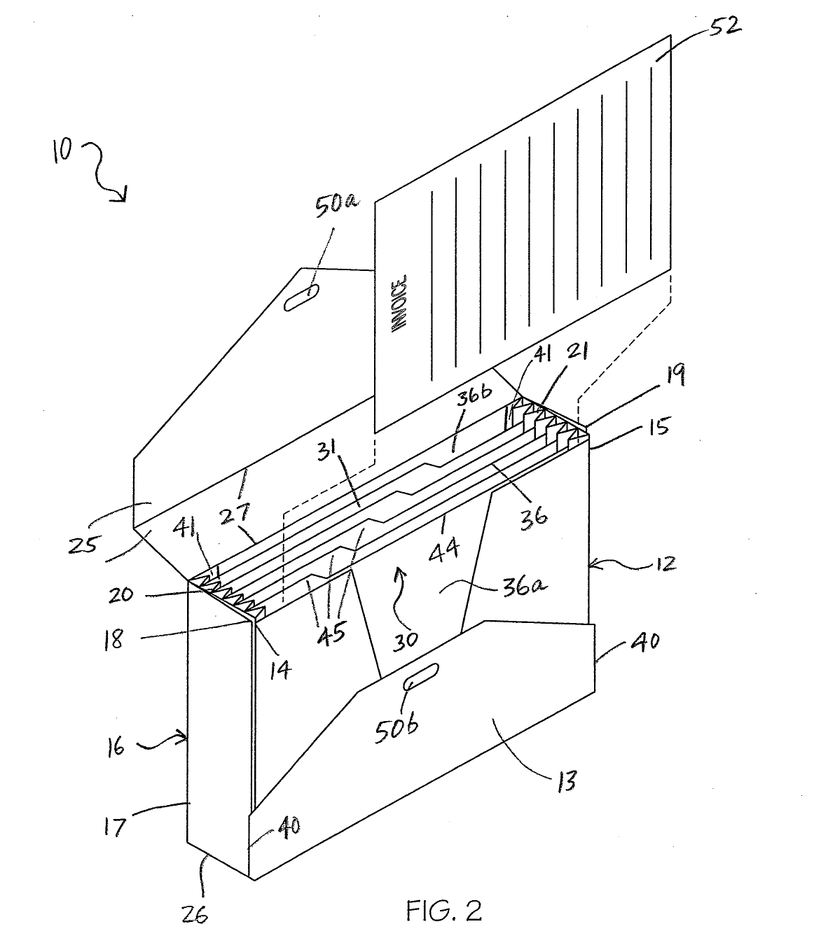

As shown in FIGS. 2 and 3, the expandable cavity 30 may provide an accordion-type connection between the front assembly 12 and rear assembly 16. The expandable cavity 30 may include a plurality of individual compartments 31 defined by a plurality of dividers 36 located in the cavity 30. As shown in FIGS. 2 and 3, each divider 36 includes three bound edges, extending partially around the perimeter thereof, and a free upper edge 44. Each divider 36 may include one or more tabs 45 formed along a free upper edge 44 thereof, wherein the tabs 45 may be shaped to protrude upwards from the free upper edge 44.

As shown in FIGS. 2 and 3, an indexing tab 45 extends from the upper edge 44 of each divider 36; the indexing tab 45 may include pictorial indicia (not shown) to represent a category of documents to be stored therein, for example, a dollar symbol to indicate invoices. The tab 45 of each divider 36 is offset from the tabs of the other dividers so the user can see all tabs 45 simultaneously. Each of the tabs 45 may include a stack of peel-away labels (not shown) wherein successive labels may be written upon, peeled away, and applied to the tabs 45 to categorized the file box 10 as desired by the user.

Each assembly 12, 16 can have a stiffness and/or thickness greater than each individual divider 36 to provide protection to the individual divider 36 and the contents of the cavity 30. Each divider 36 is connected to an adjacent divider 36 (or an adjacent assembly 12, 16) by the gussets 20, 21, 23 which may allow the adjacent dividers 36 to be moved toward or away from one another by expanding or contracting the gussets 20, 21, 23 whereby the expandable cavity 30 may be used for the storage of flat items including loose-page stationary, such as but not limited to invoices, diary pages, class notes, or the like. The gussets 20, 21, 23 and dividers 36 of the expandable cavity 30 may be manufactured in any of a variety of sizes, shapes or dimensions. The gussets 20, 21, 23 and dividers 36 may be made of a wide variety of materials ranging from specially treated fiber or paperboard to inexpensive paper, plastic or fabric.

As illustrated in FIGS. 2 and 3, the front 12 and rear assemblies 16 may be permanently bound to the side gussets 20, 21 and the bottom gusset 23. As shown in FIGS. 2 and 3, an end portion 41 of the side gussets 20, 21 are permanently attached to the front 12 and rear assembly 16 along their respective outermost vertical edges of the front and rear main panels 13, 17. As illustrated in FIG. 6, an end portion 47 of the bottom gusset 23 may be permanently attached to the front 12 and rear assembly 16 along the lowermost horizontal edges of the front and rear main panels 13, 17. The dividers 36 and/or the gussets 20, 21, 23 may also coupled to the side panels 14, 15 and 18, 19 near their respective main panels 13, 17. Any convenient attaching means, such as but not limited to an adhesive, a stitching, staples, etc. may be used. Alternatively, the front 12 and rear assembly 16 may be releasably bound to the dividers 36 or gussets 20, 21, 23, respectively, by any convenient releasably binding mechanism, such as releasable adhesives, hook and loop fastening materials, magnets, hooks, clasps having an inter-engaging geometry, or the like.

In order to use the expandable file box 10, as shown in FIGS. 2 and 3, an invoice 52 or the like may be desired to be deposited into an individual compartment 31 and stored. The individual compartments 31 may have predetermined dimensions thereby being especially convenient for invoices 52. Thus, each compartment 31 may have a size that is slightly larger than the associated invoices 52 to be stored therein. For example, each compartment 31 may have dimensions that are within about 1 inch of the dimension of the associated invoice 52, in both height and length, respectively, or that are within about 20% of the dimension of the associated invoice 52, in both height and length, respectively.

The front assembly 12 can be manually moved away from the rear assembly 16 using a telescoping or a pivoting movement (see FIGS. 4, 5 and 6), which expands the file box 10 and the cavity 30, and enhances the inspection capabilities of the file box 10 for the user. The user can then insert the invoice 52 or the like in the cavity 30. The file box 10 can then be collapsed, returning it to the position shown in FIG. 2. When the file box 10 is expanded each gusset 20, 21, 23 may be pulled generally flat, such that each compartment 31 forms a generally rectangular prism, thereby increasing the volume of the compartment 31, and consequently increasing the capacity of each compartment 31. The lower edge portion of the front main panel 13 may be provided with an outwardly extending peripheral lip 40 which engages the side panels 18, 19 to limit the inward travel of the front assembly 12 relative to the rear assembly 16. In one embodiment, the front assembly 12 is pivotally coupled to the rear assembly 16 such that the front assembly 12 can only rotate (see FIG. 4) about a horizontal axis and not linearly translate (see FIGS. 5 and 6) relative to the rear assembly 16.

As shown in FIG. 1, the rear assembly 16 may include an outwardly extending, generally flat cover flap 25, and an opposed bottom panel 26, which may be integrally formed with the rear main panel 17. The cover flap 25 and bottom panel 26 can extend from longitudinal upper and lower edges of the main panel 17 and may be made of the same piece of material. The cover flap 25 may include a plurality of folding lines 27 extending generally parallel to the upper of the main panel 17. As shown in FIGS. 4-6, the bottom panel 26 is disposed under the bottom gusset 23 such that the bottom panel 26 is free of restraint by the bottom gusset 23. The bottom panel 26 may be connected to the respective lower edges of the rear side panels 18, 19 by means of glue flaps that are hingedly connected either to the bottom panel 26 or to the side panels 18, 19 respectively. As shown in FIG. 1, the cover flap 25 can be folded along the folding lines 27 and disposed over the top opening of the expandable cavity 30 and a portion of the front main panel 13 of the front assembly 12. Thus, when the cover flap 25 is closed the cavity 30 is entirely surrounded and protected by the front 12 and rear assembly 16.

In use, the plurality of folding lines 27 enable the cover flap 25 to fold in a generally forward direction, such that the free edge of the cover flap 25 may overlap a portion of the front main panel 13 to configure the file box 10 in a closed position. As shown in FIGS. 1-3, the expandable file box 10 may include a closure mechanism 50 to retain the file box 10 in its closed position. For example, as shown in FIGS. 2-3, in one embodiment the closure mechanism 50a, 50b takes the form of a magnetic clasp which includes a first magnetic clasp portion 50a integrally mounted to the cover flap 25, and a second magnetic clasp portion 50b integrally mounted to the front main panel 13 to secure the flap 25 in its closed position and prevent expansion of the file box 10. Manipulating the clasp portions 50a, 50b into a substantially adjacent position utilizes magnetic attraction between the clasp portions 50a, 50b to secure the file box 10 in a closed position. Alternatively, an elastic band arrangement, hook and loop fastening materials, magnets, hooks, clasps, or any conventional closure mechanism may be utilized to secure the file box 10.

Having described the invention in detail and by reference to the preferred embodiments, it will be apparent that modifications and variations thereof are possible without departing from the scope of the invention.

We claim:

1. An expandable file box comprising a pair of front and rear assemblies coupled together by a gusset assembly for movement toward and away from each other, each of the front and rear assemblies includes a main panel, the main panels of the front and rear assemblies are disposed in an opposed relationship such that the gusset assembly extends between the front and rear main panels so that an expandable cavity for receiving an item is defined by the front and rear main panels and by the gusset assembly, and one of the front and rear assemblies further includes a pair of opposed side panels disposed outside the expandable cavity such that at least part of the gusset assembly is hidden from view by the side panels.

2. The expandable file box of claim 1 wherein the gusset assembly includes a pair of opposed side gussets, each of the side gussets has an internal side facing the expandable cavity and an opposed external side, and the side panels of the one of the front and rear assemblies are disposed alongside the external sides of the side gussets respectively.

3. The expandable file box of claim 2 wherein each of the side gussets is of a pleated panel structure, and the side panels of the one of the front and rear assemblies are disposed to hide the pleated panel structure from view.

4. The expandable file box of claim 1 wherein the side panels of the one of the front and rear assemblies are disposed generally perpendicular to a respective one of the main panels.

5. The expandable file box of claim 1 wherein the other of the front and rear assemblies further includes a pair of opposed side panels extending toward the one of the front and rear assembly and disposed outside the expandable cavity such that at least part of the gusset assembly is hidden from view by the side panels of the other of the front and rear assemblies.

6. The expandable file box of claim 5 wherein the side panels of the one of the rear and front assemblies are disposed in an overlapping relationship respectively with the side panels of the other of the front and rear assemblies.

7. The expandable file box of claim 5 wherein the side panels of the one of the rear and front assemblies are disposed in a face contacting relationship respectively with the side panels of the other of the front and rear assemblies for sliding movement so that the main panel of front and rear assemblies are movable toward and away from each other.

8. The expandable file box of claim 5 wherein the side panels of the other of the front and rear assemblies are disposed along respective outside surfaces of the side panels of the one of the front and rear assemblies.

9. The expandable file box of claim 2 wherein the other of the front and rear assemblies further includes a pair of opposed side panels extending toward the one of the front and rear assemblies and disposed alongside the external sides of the side gussets respectively.

10. The expandable file box of claim 9 wherein the side panels of the front and rear assemblies are disposed such that the side gussets are entirely hidden from view when the file box is viewed from either side of the file box.

11. The expandable file box of claim 6 wherein the front and rear assemblies are movable toward each other to allow the file box to take a collapsed form in which the side panels of the one of the rear and front assemblies are substantially covered respectively by the side panels of the other of the front and rear assemblies.

12. The expandable file box of claim 1 wherein the other of the front and rear assembly further includes a stopper for limiting the movement of the front and rear assembly toward each other.

13. The expandable file box of claim 12 wherein the front and rear assemblies are movable toward each other to allow the file box to take a collapsed form in which the stopper is disposed in abutment with the side panels of the one of the front and rear assemblies.

14. The expandable file box of claim 13 wherein the front assembly includes the stopper, the rear assembly includes the side panels, and respective front edges of the side panels are brought into abutment with the stopper when the files box is in the collapsed form.

15. The expandable file box of claim 1 wherein one of the front and rear assembly further includes a stopper for restricting the movement of the front and rear assembly away from each other.

16. The expandable file box of claim 15 wherein the stopper comprises a cover flap extendable from the one of the front and rear assemblies and securable to the other of the front and rear assemblies.

17. The expandable file box of claim 1 wherein one of the front and rear assembly further includes a bottom panel disposed under the expandable cavity.

18. The expandable file box of claim 1 wherein the gusset assembly is free of restraint by the side panels of the one of the front and rear assemblies.

19. The expandable file box of claim 1 wherein the front and rear assemblies are pivotable about a horizontal axis with respect to the other.

20. The expandable file box of claim 1 wherein the gusset assembly includes one or more dividers for defining two or more separate compartments within the cavity.

21. An accordion folder comprising:
a pair of front and rear opposed panels interconnected by an accordion connector to define an expandable cavity for receiving an item, the accordion connector including a pair of opposed pleated side walls; and
a first pair of opposed cover panels extending from one of the front and rear panels to be disposed alongside the pleated side walls respectively so that at least part of the pleated side walls is hidden from view by the cover panels.

22. The accordion folder of claim 21 wherein a second pair of opposed cover panels extend from the other of the front and rear panels to be disposed alongside the pleated side walls respectively such that at least part of the cover panels of the first pair is hidden from view by the cover panels of the second pair.

23. The accordion folder of claim 22 wherein the front and rear panels are movable toward each other to allow the accordion folder to take a collapsed form in which the cover panels of the first pair are substantially covered respectively by the cover panels of the second pair.

24. The accordion folder of claim 22 wherein the cover panels of the first pair are disposed in a face contacting relationship respectively with the cover panels of the second pair for sliding movement so that the front and rear panels are movable toward and away from each other.

25. The accordion folder of claim 21 wherein the accordion connector further includes a pleated bottom wall extending between the pleated side walls.

26. The accordion folder of claim 25 wherein a bottom cover panel extends from one of the front and rear panels to be disposed under the pleated bottom wall.
